(19) United States
(12) Patent Application Publication
(10) Pub. No.: US 2007/0011092 A1
(43) Pub. Date: Jan. 11, 2007

(54) System and method for controlling on-demand service delivery costs

(76) Inventors: Ellis E. Bishop, Austin, TX (US); Randy S. Johnson, O'Fallon, MO (US); Linda D. Kalmes, Loveland, CO (US); James H. Merritt SR., Lexinggton, KY (US); Tedrick N. Northway, Wood River, IL (US); H. William Rinckel, Prospect, CT (US)

Correspondence Address: IBM CORPORATION (RUS);c/o Rudolf O Siegesmund Gordon & Rees, LLp, 2100 Ross Avenue, Suite 2600, DALLAS, TX, 75201, US

(21) Appl. No.: 11/174,960

(22) Filed: Jul. 5, 2005

(51) Int. Cl. G06Q 40/00

(52) U.S. Cl. 705/40

(57) ABSTRACT

A system and method for creating a hybrid invoice for services provided to a customer by an on-demand data center are disclosed. The method comprises providing a shared computing environment wherein computing resources are shared between the customer and at least one other user; allocating sufficient computing resources from the shared computing environment to provide a requested service; recording in a database the number of computing resource units required to provide the requested service; extracting from the database the number of computing resource units consumed by the customer during a billing period; and calculating a cost for providing the number of computing resource units consumed by the customer during the billing period.

### FIELD OF THE INVENTION

The subject matter of the invention includes apparatus and corresponding methods for performing data processing or calculating operations in which a charge for services is determined.

### BACKGROUND OF THE INVENTION

For many years, network technology has enabled the sharing of, and remote access to, computing resources around the world. One computer can readily exchange data with a computer down the hall or in another country. Of course, it did not take long for the business world to harness the power of global networks, and network technology has fueled the growth of an entire new industry focused on delivering services across these networks.

In a “traditional” service model, customers share a service provider's management services, but each customer purchases or leases specific resources for the customer's exclusive benefit. The customer may purchase or lease the resources directly from the provider or from a third party. Regardless of their origins, though, such a purchase or lease may require extensive, time-consuming negotiations based upon the customer's anticipated requirements. The customer typically is billed for using an entire resource (such as a processor or storage device), as well as the cost of labor needed to support the service. If the customer's requirements are less than anticipated, then the customer effectively has wasted resources. If, however, the customer's requirements are greater than anticipated, then the customer may have to enter into additional time-consuming negotiations for the necessary resources.

Alternatives to the traditional service model, though, are able to anticipate and meet customers' processing needs as their requirements grow, while maximizing existing resources. One such alternative pioneered by International Business Machines Corp. allows a service provider to allocate resources to customers “on-demand” as the customers' needs change. In this on-demand service model, customers share computing and networking resources. In one implementation of the on-demand model, a service provider creates “logical” partitions of computing resources on primary processing units (commonly known as “mainframe” computers). Typically, an on-demand service provider contracts with several customers to provide a certain level of service to each customer, and creates a logical partition (LPAR) of resources for each customer to fulfill its obligations. Unlike traditional service contracts, an on-demand service contract generally requires that the customer be billed only for resources actually used, and for fixed costs not directly related to usage (such as labor costs incurred in support of the contract).

Thus, an on-demand service provider must constantly monitor each customer's use of allocated resources in order to bill each customer in accordance with the applicable service contract. There currently is no cost-effective system for monitoring a customer's use of resources in an on-demand environment.

### SUMMARY OF THE INVENTION

The invention described in detail below is a system and method for creating a hybrid invoice for services provided to a customer by an on-demand data center. The method comprises providing a shared computing environment wherein computing resources are shared between the customer and at least one other user; allocating sufficient computing resources from the shared computing environment to provide a requested service; recording in a database the number of computing resource units required to provide the requested service; extracting from the database the number of computing resource units consumed by the customer during a billing period; and calculating a cost for providing the number of computing resources units consumed by the customer during the billing period; whereby an invoice containing usage data and cost recovery data for the billing period can be provided to the customer for payment.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 is an overview of the architecture of an on-demand operating environment in which the present invention is practiced;

FIG. 2 illustrates the delivery of a service in an embodiment of the present invention; and

FIG. 3 is a flowchart of an embodiment of the present invention.

### DETAILED DESCRIPTION OF THE PREFERRED EMBODIMENT

The on-demand operating environment of the present invention is based upon the concepts of a Service Oriented Architecture (SOA). The goal of an SOA can be described as bringing the benefits of loose coupling and encapsulation to integration at an enterprise level. In an SOA, every application or computing resource is modeled as a service that implements a specific, identifiable function (or set of functions). In general, a service is a stateless function that accepts a request and returns a response through a well defined interface. Services also can perform discrete units of work such as editing and processing a transaction. Services are not dependent on the state of other functions or processes. In an on-demand environment, the services often implement specific business functions, but also may implement interfaces or other operating functions. It is also important to note that the terms “provider” and “consumer” may have a variety of meanings that depend on context in the on-demand operating environment. The term “provider,” for instance, can refer either to an enterprise or to a single function that performs a service in response to a request from a consumer. Likewise, the term “consumer” or “customer” may refer either to an enterprise or to a function that consumes the result of the service supplied by a provider.

An SOA applies known concepts that have been proven by object-oriented development, component-based design, and enterprise application integration technology. A fundamental concept of an SOA is that it is independent of any specific technology, and an SOA may be implemented in a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation.

Services in an SOA, including the on-demand operating environment associated with the present invention, communicate with each other by exchanging structured information over a network or service bus, typically through messages or documents. The services' capabilities are defined by interfaces declaring messages they can produce or consume, policy annotations declaring a quality of service required or provided, and choreography annotations declaring behavioral constraints that must be respected in service interactions. The actual implementation of any specific service is hidden from the service requester, which allows new and existing applications to be quickly combined into new contexts.

In an on-demand data center, process software is shared, simultaneously serving multiple customers in a flexible, automated fashion. It is standardized, requiring little customization, and it is scalable, providing capacity on demand in a pay-as-you-go model.

The process software can be stored on a shared file system accessible from one or more servers. The process software is executed via transactions that contain data and server processing requests that use computing resources on the accessed server. The accessed server also may make requests of other servers that require the use of computing resources. The use or consumption of computing resources is measured in units of time such as minutes, seconds, or hours. A CPU is one example of a computing resource, but other resources that may be consumed and measured include (but are not limited to) network bandwidth, memory, storage, packet transfers, complete transactions, etc.

When multiple customers use the same process software application, their transactions are differentiated by the parameters included in the transactions that identify the unique customer and the type of service for that customer. The service provider records each customer's use of the computing resources during each transaction. When the number of transactions in progress on any one server reaches a number that begins to affect the performance of that server, other servers are accessed to increase the capacity and to share the workload. Likewise, when the number of transactions approaches the capacity limits of other processing resources, additional network bandwidth, memory, storage, etc. are added to share the workload.

The measurements of use recorded for each service and customer are sent to a collecting server that sums the measurements of use for each customer for each service that was processed anywhere in the network of servers that provide the shared execution of the process software. The summed measurements of use are periodically multiplied by unit costs and the resulting total process software application costs are sent to the customer, indicated on a web site accessed by the customer, or both. The customer then remits payment to the service provider. Alternatively, the service provider may request payment directly from a customer account at a banking or financial institution.

Further in the alternative, if the service provider also is a customer of the customer that uses the process software application, the payment owed to the service provider may be reconciled to the payment owed by the service provider to minimize the transfer of payments.

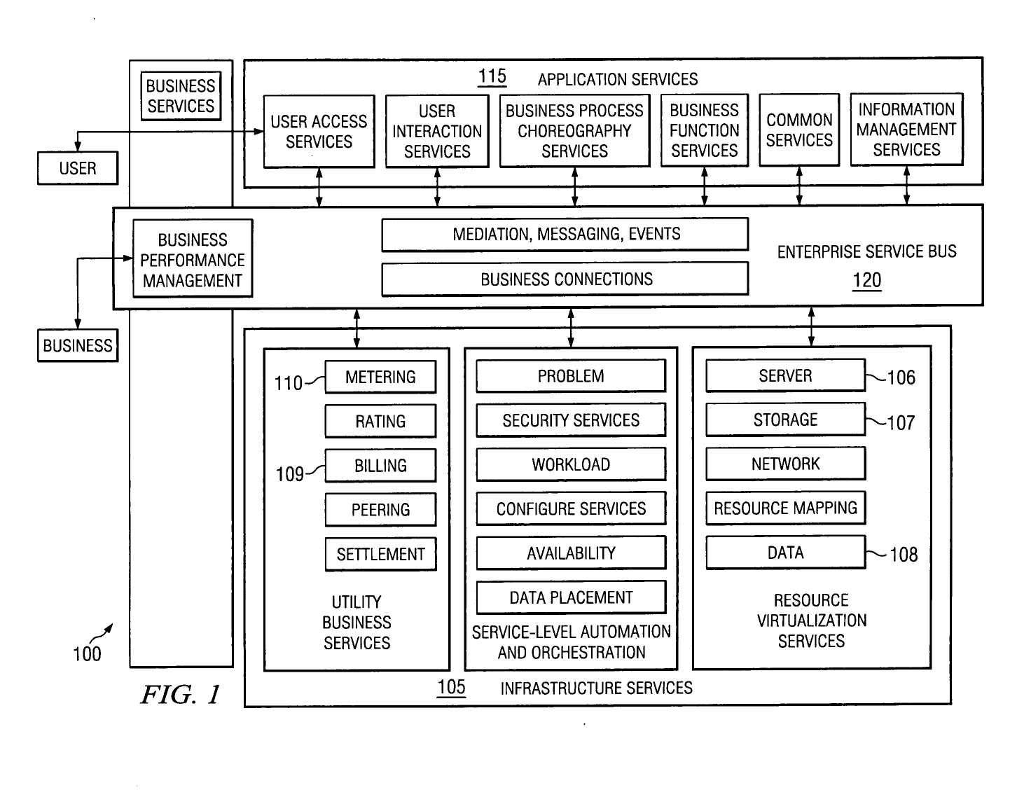

FIG. 1 provides an overview of the architecture of the on-demand operating environment 100 of the present invention. At infrastructure services level 105, components of the environment may be system objects such as servers 106, storage 107, and data 108, or business objects such as billing 109 and metering 110, defined for particular vertical industries or more generally, as they apply horizontally across industries. At the application services level 115, components are dynamically integrated application modules that constitute sophisticated, yet much more flexible applications.

Typically, a specific on-demand business service relies on many other services in its implementation. In FIG. 1, all interactions between services flow through Enterprise Service Bus (ESB) 120. The ESB is emerging as a service oriented infrastructure component that makes large-scale implementation of SOA principles manageable in a heterogeneous world. An ESB also is a well-known concept in the industry and need not be described in detail here, but in general ESB 120 facilitates mediated interactions between service end-points. ESB 120 supports event-based interactions, as well as message exchange for service request handling. For both events and messages, mediations can facilitate interactions by, for example, locating services that provide requested capabilities, or by handling interface mismatches between requesters and providers that are compatible in terms of their capabilities.

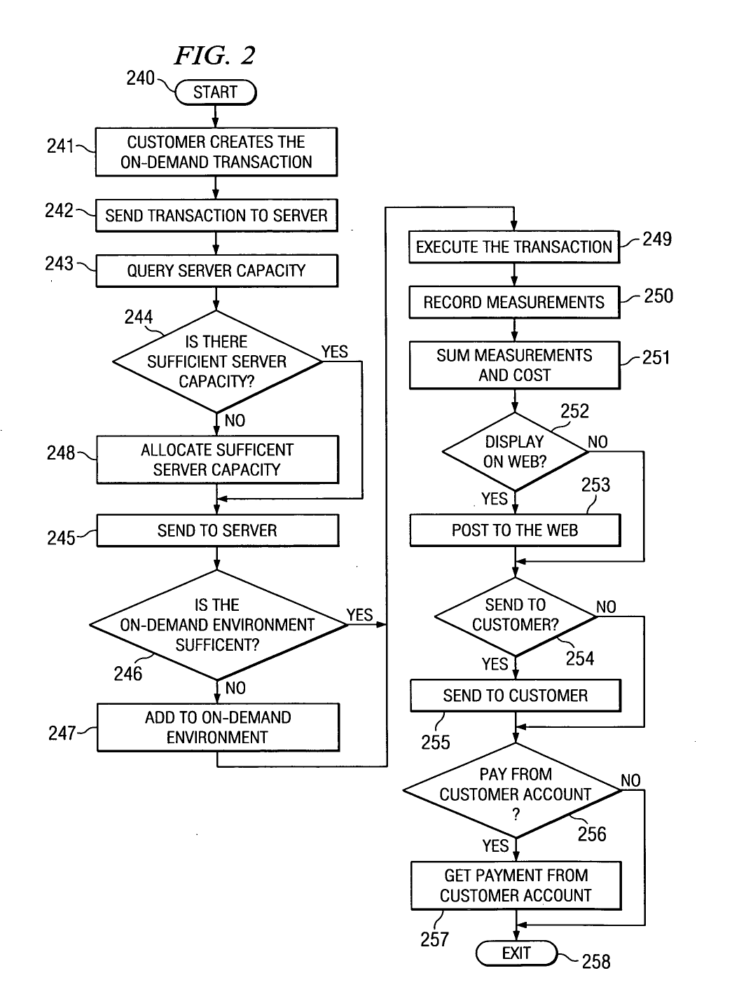

FIG. 2 illustrates the operation of an on-demand process. Step 240 begins the on-demand process. A transaction is created that contains the unique customer identification, the requested service type, and any service parameters that further specify the type of service (241). The transaction is then sent to the main server (242). In an on-demand environment, the main server initially may be the only server, but other servers may be added to the on-demand environment as processing resources are consumed.

The server central processing unit (CPU) capacities in the on-demand environment are queried (243). The CPU requirement of the transaction is estimated, then the server's available CPU capacity in the on-demand environment are compared to the transaction CPU requirement to see if there is sufficient CPU capacity available in any server to process the transaction (244). If there is insufficient server CPU capacity available, then additional server CPU capacity is allocated to process the transaction (248). If sufficient server CPU capacity already is available, then the transaction is sent to a selected server (245).

Before executing the transaction, a check is made of the remaining on-demand environment to determine if the environment has sufficient capacity available for processing the transaction. This environment capacity includes, but is not limited to, network bandwidth, processor memory, storage, etc. (246). If sufficient capacity is not available, then capacity is added to the on-demand environment (247). Next, the software required to process the transaction is accessed, loaded into memory, and then the transaction is executed (249).

The usage measurements are recorded in a file or database (250), referred to below as the “usage database.” The usage measurements consist of the portions of on-demand resources that are used to process the transaction. The resources recorded include, but are not limited to, network bandwidth, processor memory, storage, and CPU cycles. The usage measurements are summed, multiplied by unit costs, and then recorded as a charge to the requesting customer (251).

If the customer has requested that the on-demand costs be posted to a web site (252), then they are posted (253). If the customer has requested that the on-demand costs be sent via email to a customer address (254), then they are sent (255). If the customer has requested that the on-demand costs be paid directly from a customer account (256), then payment is received directly from the customer account (257).

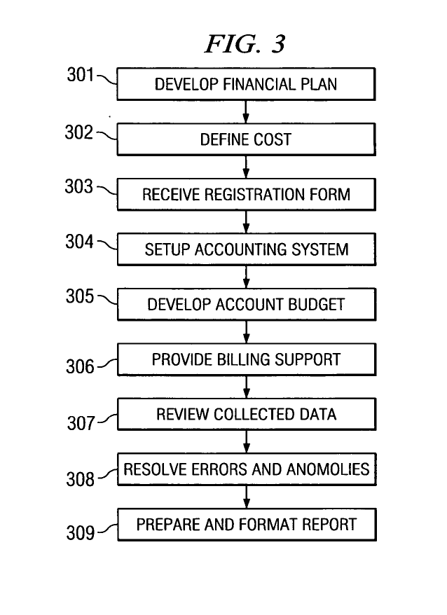

To control the costs of delivering services through an on-demand data center, the center implements a proactive process of developing an annual on-demand financial plan (301), ensuring proper accounting system setup for each customer (303-304), coordinating and maintaining individual account budget plans (305), and providing billing support to handle inquiries and adjustments (306), as illustrated in FIG. 3. The on-demand financial plan is implemented by identifying the equipment and labor costs of delivering on-demand services, including the costs of system hardware (e.g. CPUs, tape, disks, etc.), software use, and other fixed costs; and determining the customer cost recovery required. The on-demand data center determines the unit cost of usage by defining costing parameters (302) consistent with the financial plan, and then implementing and monitoring those definitions.

An on-demand data center uses a combination of identifiers to capture and record any given customer's consumption of resources. A “customer identifier” is an enterprise-level identification that uniquely identifies a given customer to an on-demand service provider. A given customer cannot have more than one customer identifier. A “billing identifier” is a contract-level identification that uniquely identifies a single contract between a customer and the service provider. A given customer may have many different billing identifiers. An on-demand data center uses “sub-client identifiers” to allocate service costs to an account represented by a billing identifier. More than one sub-client identifier may be used to track costs for any given account. For example, one sub-client identifier may be used to track logical partitioning costs, while another may be used to track backup and recovery costs.

To ensure proper accounting system setup for each customer, the on-demand data center provides a registration form that must be completed and submitted for each new account (303). This form establishes a billing identifier and one or more sub-client identifiers for the account, and links the account to a specific customer through a customer identifier. The links between the accounts and customers are recorded in a file or database for later use. This file or database is referred to below as the “billing map.” In alternative embodiments of the present invention, the billing map may be integrated into the usage database or may be an independent data structure. Information captured in the appropriate fields of the registration form ensures that downstream accounting information is correctly captured.

To measure and record a customer's usage of a resource, as described above (e.g. step 250), each resource is instrumented to meter or count assets and services consumed during the transaction. The billing identifier and any sub-client identifiers associated with the transaction (collectively referred to herein as the “transaction data”) also are recorded with the consumption measurement. At the request of a customer or at the end of a given billing period, which may vary according to contractual obligations, an on-demand data center extracts all consumption measurements associated with a billing identifier, sub-client identifier, or any combination thereof. The data center also extracts any sub-client identifiers associated with the extracted consumption measurements, along with the hardware and software configuration provided to service the transactions. The associated customer identifier then is extracted from the billing map.

The data center then reviews the collected data for errors and anomalies (307), and resolves them if necessary (308). In one embodiment of the present invention, the data center may adjust the unit costs based upon a customer's usage, such as discounts for volume or off-peak usage. All data is reconciled, and then a report of chargeback, cost recovery, and usage information is sent to the appropriate account representative (309), who is responsible for ensuring that the service provider fulfills all contractual obligations and for ensuring that the service provider receives compensation for delivered services. Examples of report formats that may be generated from the collected data include charges for a customer service period, a service period summary file record, a summary of services that were provided during a service period, items with recurring service charges, CPU usage, storage usage, and other services. The inventive process described above further provides for dynamic adjustment of the costing parameter definitions for a customer if the collected data indicates that the customer exceeds contractual usage thresholds.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A method for creating a hybrid invoice for services provided to a customer by an on-demand data center, the method comprising:
providing a shared computing environment wherein computing resources are shared between the customer and at least one other user;
allocating sufficient computing resources from the shared computing environment to provide a requested service;
recording in a database the number of computing resource units required to provide the requested service;
extracting from the database the number of computing resource units consumed by the customer during a billing period; and
calculating a cost for providing the number of computing resources units consumed by the customer during the billing period;
whereby an invoice containing usage data and cost recovery data for the billing period can be provided to the customer for payment.

2. The method of claim 1 wherein:
the requested service and the customer are identified in a transaction request received from the customer;
a billing identifier that associates an account with the customer is recorded in the database with the number of computing resource units consumed during the transaction;
the number of computing resource units consumed by the customer for the account during the billing period are extracted from the database; and
the cost for providing the number of computing resources units consumed by the customer for the account during the billing period are calculated.

3. The method of claim 2 wherein the cost is calculated by developing an annual financial plan that estimates the cost of the computing resources required to provide service, dividing the estimated cost by the number of computing resource units to produce a unit cost, and multiplying the unit cost by the number of computing resources consumed by the customer for the account during the billing period.

4. The method of claim 2 wherein the computing resources comprise one or more logical partitions of a storage medium.

5. The method of claim 2 wherein the computing resources comprise one or more data processors.

6. The method of claim 2 wherein the computing resources comprise one or more network connections.

7. The method of claim 2 further comprising sending the invoice to an address designated by the customer.

8. The method of claim 7 wherein the invoice is sent electronically and the address is an electronic mail address.

9. The method of claim 2 further comprising posting the invoice data to a website accessible to the customer.

10. The method of claim 2 further comprising debiting the payment of the account from funds designated by the customer.

11. A system for creating a hybrid invoice for services provided to a customer in an on-demand data center, the system comprising:
means for metering the number of computing resource units consumed by the customer;
means for recording the number of computing resource units metered;
means for extracting the number of computing resource units metered during a billing period; and
means for calculating a cost for providing the number of computing resources units consumed by the customer for the account during the billing period;
whereby an invoice containing usage data and cost recovery data for the billing period can be provided to the customer for payment of the account.

12. The system of claim 11 wherein the computing resources comprise one or more logical partitions of a storage medium.

13. The system of claim 11 wherein the computing resources comprise one or more data processors.

14. The system of claim 11 wherein the computing resources comprise one or more network connections.

15. The system of claim 11 further comprising means for sending the invoice to an address designated by the customer.

16. The system of claim 11 further comprising means for electronically sending the invoice to an electronic mail address designated by the customer.

17. The system of claim 11 further comprising means for posting the invoice data to a website accessible to the customer.

18. The system of claim 11 further comprising means for debiting the payment of the account from funds designated by the customer.

19. A system for billing a service provided to a customer in an on-demand data center, the system comprising:
a process software that provides the service;
an enterprise service bus coupled to the process software;
a metering component coupled to the enterprise service bus that records the number of computing resources required to provide the service through the process software; and
a billing component coupled to the enterprise service bus that extracts the number of computing resource units recorded during a billing period and calculates a cost for providing the number of computing resources units;
whereby an invoice containing usage data and cost recovery data for the billing period can be provided to the customer for payment.
